(19) United States
(12) Patent Application Publication
(10) Pub. No.: US 2024/0154279 A1
(43) Pub. Date: May 9, 2024

(54) BATTERY MODULE AND ELECTRICAL DEVICE

(71) Applicant: Dongguan Poweramp Technology Limited, Dongguan (CN)

(72) Inventors: Kunlong LI, Dongguan (CN); Chengxiang ZHANG, Dongguan (CN); Pengfei WANG, Dongguan (CN); Shenbo WANG, Dongguan (CN)

(73) Assignee: Dongguan Poweramp Technology Limited, Dongguan (CN)

(21) Appl. No.: 18/409,841

(22) Filed: Jan. 11, 2024

Related U.S. Application Data
(63) Continuation of application No. PCT/CN2022/105196, filed on Jul. 12, 2022.

(30) Foreign Application Priority Data
Jul. 14, 2021 (CN) 202110796433.2

(51) Int. Cl. H01M 50/588; H01M 50/178; H01M 50/184; H01M 50/211; H01M 50/557; H01M 50/593

(52) U.S. Cl. CPC H01M 50/588; H01M 50/178; H01M 50/184; H01M 50/211; H01M 50/557; H01M 50/593

(57) ABSTRACT

A battery module includes multiple cells and a bracket. The multiple cells are stacked along a first direction. Each cell includes a first terminal and a second terminal. The bracket includes multiple groups of through-holes. Each group of through-holes includes a first terminal through-hole and a second terminal through-hole. The first terminal and the second terminal of a same cell pass through the first terminal through-hole and the second terminal through-hole in a same group of through-holes. The multiple groups of through-holes include a first group of through-holes, a second group of through-holes, and third groups of through-holes. Along the first direction, a distance D1 between the first terminal through-hole in the first group of through-holes and the second terminal through-hole in a third group of through-holes adjacent to the first group of through-holes is greater than a distance D3 between two adjacent third groups of through-holes.

### CROSS-REFERENCE TO RELATED APPLICATIONS

This application is a continuation application of International Application No. PCT/CN2022/105196, filed on Jul. 12, 2022, which claims the benefit of priority of Chinese patent application 202110796433.2, filed on Jul. 14, 2021, the contents of each are incorporated herein by reference in its entirety.

### TECHNICAL FIELD

This application relates to the technical field of cell stacking, and in particular, to a battery module and an electrical device.

### BACKGROUND

Many cells on the market at present are prone to a short circuit if tabs of two adjacent cells are disposed too close to each other during stacking, thereby posing safety hazards to some extent.

### SUMMARY

In view of the foregoing situation, it is necessary to provide a battery module and an electrical device to reduce risks of short circuits of cells.

An embodiment of this application provides a battery module, including a plurality of cells and a bracket. The plurality of cells are stacked along a first direction. Each cell includes a first terminal and a second terminal. A polarity of the first terminal is opposite to a polarity of the second terminal. The bracket includes a plurality of groups of through-holes. Each group of through-holes includes a first terminal through-hole and a second terminal through-hole. The first terminal and the second terminal of a same cell pass through the first terminal through-hole and the second terminal through-hole in a same group of through-holes respectively. The plurality of groups of through-holes include a first group of through-holes, a second group of through-holes, and third groups of through-holes located between the first group of through-holes and the second group of through-holes. Along the first direction, a distance D1 between the first terminal through-hole in the first group of through-holes and the second terminal through-hole in a third group of through-holes adjacent to the first group of through-holes is greater than a distance D3 between two adjacent third groups of through-holes.

This increases the distance between the first terminal inside the first terminal through-hole in the first group of through-holes and the second terminal inside the second terminal through-hole in the third group of through-holes adjacent to the first group of through-holes, reduces risks of short circuits between the first terminal and the second terminal, and increases a connection area, thereby making it convenient to dispose a first connecting piece, and in turn, reducing risks of short circuits between the first connecting piece and the second terminal inside the adjacent third group of through-holes.

In the two adjacent third groups of through-holes, a distance between the first terminal through-hole in one of the two adjacent third groups of through-holes and the second terminal through-hole in the other two adjacent of the third groups of through-holes is D3, and the first terminal through-hole in the one of the two adjacent third groups of through-holes and the second terminal through-hole in the other of the two adjacent third groups of through-holes are disposed opposite to each other along the first direction.

In some embodiments of this application, a difference between D1 and D3 is greater than 6 mm.

The foregoing embodiment helps to increase a connection area between the first connecting piece and the first terminal, and reinforce a weld region between the first connecting piece and the first terminal.

In some embodiments of this application, a distance between the second terminal through-hole in the second group of through-holes and the first terminal through-hole in a third group of through-holes adjacent to the second group of through-holes is D2, and D2 is less than D3.

The foregoing embodiment can reduce the distance between the second group of through-holes and the adjacent third group of through-holes, and adjust the distance between the first terminal through-hole in the first group of through-holes and the second group of through-holes along the first direction X.

In some embodiments of this application, along the first direction, a distance d1 between the first terminal through-hole in the first group of through-holes and the second terminal through-hole in the second group of through-holes is equal to a distance d2 between the second terminal through-hole in the first group of through-holes and the first terminal through-hole in the second group of through-holes.

The foregoing embodiment helps to make the following two lengths consistent by cutting: a length by which the first terminal extends beyond the cell housing, and a length by which the second terminal extends beyond the cell housing, thereby facilitating production.

In some embodiments of this application, the bracket further includes a base plate and a plurality of groups of protruding portions that are spaced apart. The base plate includes a first side and a second side that are disposed opposite to each other along a second direction. The plurality of groups of protruding portions are located on the first side of the base plate. Viewed along the second direction, the plurality of groups of protruding portions include a first group of protruding portions located between the first group of through-holes and the third group of through-holes adjacent to the first group of through-holes, a second group of protruding portions located between the second group of through-holes and the third group of through-holes adjacent to the second group of through-holes, and a third group of protruding portions located between the first group of protruding portions and the second group of protruding portions; and the first group of protruding portions includes a first part located between the first terminal through-hole and the second terminal through-hole in the adjacent third group of through-holes, and a second part located between the second terminal through-hole and the first terminal through-hole in the adjacent third group of through-holes. Projected along the second direction, a width of a projection of the first part on the base plate along the first direction is W1, a width of a projection of the second part on the base plate along the first direction is W2, and W1 is greater than W2.

The foregoing embodiment helps the first terminal of the first part to keep away from the second terminal inside the adjacent third group of through-holes along the first direction X, increase the distance between the first terminal and the second terminal, and reduce risks of short circuits between the first terminal and the second terminal.

In some embodiments of this application, along the first direction, a distance between the first part and the second group of protruding portions is equal to a distance between the second part and the second group of protruding portions.

In some embodiments of this application, each group of protruding portions gradually diminishes in size along an opposite direction of the second direction.

The foregoing embodiment exerts a guiding effect on the movement of the first terminal and the second terminal, and guides the first terminal and the second terminal to move close to the base plate.

In some embodiments of this application, when viewed along the second direction, the second group of protruding portions includes a third part located between a second terminal through-hole in the second group of through-holes and a first terminal through-hole in the third group of through-holes adjacent to the second group of through-holes, and a fourth part located between a first terminal through-hole in the second group of through-holes and a second terminal through-hole in the third group of through-holes adjacent to the second group of through-holes. Projected along the second direction, a width of a projection of the third part on the base plate along the first direction is W3, a width of a projection of the fourth part on the base plate along the first direction is W4, and W3 is less than W4.

During the assembling, the foregoing embodiment helps to provide a guidance and achieve the following effects: the second terminal inside the second terminal through-hole in the second group of through-holes is disposed close to the adjacent third group of through-holes; and the distance between the first terminal through-hole in the second group of through-holes and the adjacent third group of through-holes is equal to D3.

In some embodiments of this application, along the first direction, the base plate includes a second lateral edge and a first lateral edge, a distance between the second terminal through-hole in the second group of through-holes and the first lateral edge is d21, a distance between the first terminal through-hole in the second group of through-holes and the first lateral edge is d22, and d21 is greater than d22.

The foregoing embodiment helps to increase the distance between the second terminal through-hole in the second group of through-holes and the lateral edge of the base plate, and facilitates welding between the second terminal connecting portion and the second connecting piece.

In some embodiments of this application, along the first direction, the base plate includes a second lateral edge and a first lateral edge, and an end that is of the first terminal through-hole in the first group of through-holes and that is oriented away from the second group of through-holes penetrates the second lateral edge.

The foregoing embodiment makes it convenient to fold outward the first terminal connecting portion disposed inside the first terminal through-hole in the first group of through-holes, and weld the first terminal connecting portion to the first connecting piece.

In some embodiments of this application, the bracket includes a third side and a fourth side that are disposed opposite to each other along a third direction. The bracket includes an opening made on the third side, a plurality of groups of interstices are formed between the plurality of groups of protruding portions. Along the third direction, the opening communicates with the plurality of groups of interstices.

In some embodiments of this application, a first beveled face and a second beveled face are disposed at ends that are of the plurality of groups of protruding portions and that are located on the third side. A distance between the first beveled face and the second beveled face of a same group of protruding portions along the first direction increases gradually from the third side to the fourth side.

The foregoing embodiment helps to guide the first terminal and the second terminal into an interstice between two adjacent groups of protruding portions, thereby improving the success rate of docking the cell to the bracket.

In some embodiments of this application, the cell further includes a cell housing and an electrode assembly. The cell housing includes an accommodation portion and an edge sealing portion extending outward from the accommodation portion. The accommodation portion includes a first surface and a second surface that are disposed opposite to each other along the first direction. The first terminal and the second terminal protrude beyond the cell housing from the edge sealing portion. The electrode assembly is accommodated in the accommodation portion. The first terminal and the second terminal are electrically connected to the electrode assembly.

In some embodiments of this application, the edge sealing portion is disposed between a plane where the first surface is located and a plane on where the second surface is located, and the edge sealing portion is closer to the first surface than the second surface.

In some embodiments of this application, the cell housing includes a first region and a second region. The first region 21a contains a first space. The electrode assembly is disposed in the first space. The second region is a flat plate-like structure. The first region is connected to the second region. A lateral edge of the first region is connected to the lateral edge of the second region to form a plurality of edge sealing portions. The first terminal and the second terminal extend beyond the cell housing from one of the edge sealing portions.

In some embodiments of this application, the first surface is disposed in the second region, and the second surface is disposed in the first region.

In some embodiments of this application, two first surfaces or two second surfaces of any two adjacent cells are disposed opposite to each other.

In some embodiments of this application, the first terminal is connected to the second terminal between at least two adjacent cells, or the first terminal of one cell is connected to the first terminal of an adjacent cell.

In some embodiments of this application, the first terminal and the second terminal that are connected to each other are connected together by bending toward each other. The first terminal includes a first terminal connecting portion that has passed through the first terminal through-hole. The second terminal includes a second terminal connecting portion that has passed through the second terminal through-hole. The battery module further includes a plurality of conductive pieces. The plurality of conductive pieces are disposed on a side that is of the base plate and that is oriented facing away from the protruding portion. The first terminal connecting portion and the second terminal connecting portion are connected to the conductive piece. The bracket further includes a partitioning portion located on the first side of the base plate, and the partitioning portion is disposed between the first terminal through-hole and the second terminal through-hole in a same group of through-holes.

The partitioning portion in the foregoing embodiment can reduce the probability of other foreign substances dropping into a space between the first terminal through-hole and the second terminal through-hole in the same group, thereby reducing the risk of a short circuit between the first terminal and the second terminal caused by the foreign substances. Optionally, the partitioning portion can reinforce the structural strength of the bracket.

In some embodiments of this application, the battery module further includes a sampling piece. The sampling piece is disposed on a side that is of the base plate and that is oriented facing away from the protruding portion, and is connected to the conductive piece.

In some embodiments of this application, the battery module further includes a first connecting piece and a second connecting piece. One end of the first connecting piece is connected to the first terminal that passes through the first terminal through-hole in the first group of through-holes. Another end of the first connecting piece includes a first connecting portion. One end of the second connecting piece is connected to the second terminal that passes through the second terminal through-hole in the second group of through-holes. Another end of the second connecting piece includes a second connecting portion. The first connecting portion and the second connecting portion are located on a same side of the base plate.

The foregoing embodiment helps to connect external devices and improve space efficiency.

In some embodiments of this application, the bracket further includes a first insulation rod. One end of the first insulation rod is connected to the base plate, and another end abuts on the first connecting piece.

In the foregoing embodiment, the first insulation rod can well support the first connecting piece, and reduce the probability of a short circuit caused by contact between the first connecting piece and the bent first terminal or second terminal.

In some embodiments of this application, the bracket further includes an insulation block. The insulation block is disposed on the second side of the base plate and is located between the first terminal through-hole in the first group of through-holes and an adjacent third group of through-holes. Along the third direction, a length of the insulation block is greater than a length of the first terminal through-hole in the first group of through-holes.

The insulation block in the foregoing embodiment is configured to obstruct the first connecting piece and the first terminal welded on the first connecting piece from contacting the adjacent second terminal, thereby reducing risks of short circuits between the first connecting piece and the second terminal in the third group of through-holes.

An embodiment of this application further provides an electrical device, including the foregoing battery module.

The battery module and the electrical device increase the distance between the first terminal and the second terminal by increasing the distance between the first terminal through-hole in the first group of through-holes and the second terminal through-hole in the third group of through-holes adjacent to the first group of through-holes. This reduces risks of short circuits between the first terminal and the second terminal caused by deficient spacing, increases the connection area, and makes it convenient to dispose the first connecting piece, thereby reducing risks of short circuits between the first connecting piece and the second terminal inside the adjacent third group of through-holes.

### BRIEF DESCRIPTION OF DRAWINGS

FIG. 1 is a schematic exploded view of a battery module according to an embodiment of this application;

FIG. 2 is a first view of a cell connected to a bracket according to an embodiment of this application;

FIG. 3 is a first view of a cell according to an embodiment of this application;

FIG. 4 is a second view of a cell according to an embodiment of this application;

FIG. 5 is a schematic exploded view of an unpackaged cell according to an embodiment of this application;

FIG. 6 is a first view of a bracket according to an embodiment of this application;

FIG. 7 is a second view of a bracket according to an embodiment of this application;

FIG. 8 is a schematic structural diagram of tabs of the cell are still to be bent according to an embodiment of this application;

FIG. 9 is a schematic structural diagram of cells stacked together according to an embodiment of this application;

FIG. 10 is a schematic structural diagram of stacked cells and bent tabs according to an embodiment of this application;

FIG. 11 is a schematic structural diagram of a sampling piece and a conductive piece mounted on a bracket according to an embodiment of this application;

FIG. 12 is a second view of a cell connected to a bracket according to an embodiment of this application;

FIG. 13 is a schematic structural diagram of a second connecting piece connected to a bracket according to an embodiment of this application;

FIG. 14 is a schematic structural diagram of a first connecting piece and a second connecting piece that are connected to a bracket according to an embodiment of this application;

FIG. 15 is a schematic structural diagram of an electrical device according to an embodiment of this application;

FIG. 16 is a schematic structural diagram of a distance between a first group of through-holes and an adjacent third group of through-holes according to an embodiment of this application;

FIG. 17 is a schematic structural diagram of a distance between two adjacent third groups of through-holes according to an embodiment of this application; and

FIG. 18 is a schematic structural diagram of a distance between a first group of through-holes and a second group of through-holes according to an embodiment of this application.

### REFERENCE NUMERALS OF MAIN COMPONENTS

Battery module 100
Bracket 1
Base plate 11
First lateral edge 11A
Second lateral edge 11B
First side 11a
Second side 11b
Third side 11c
Fourth side 11d
Opening 11e
Through-hole 111
First group of through-holes 111a
Second group of through-holes 111b
Third group of through-holes 111c
First terminal through-hole 1111
Second terminal through-hole 1112
Protruding portion 12
First beveled face 12a
Second beveled face 12b
First group of protruding portions 121
First part 121a
Second part 121b
Second group of protruding portions 122
Third part 122a
Fourth part 122b
Fifth part 121c
Third group of protruding portions 123
Fourth group of protruding portions 124
Fifth group of protruding portions 125
Partitioning portion 13
First insulation rod 14
Second insulation rod 15
Insulation block 16
Cell 2
Cell housing 21
First region 21a
Second region 211b
First space 211a
Accommodation portion 211
First surface 2111
Second surface 2112
Edge sealing portion 212
Electrode assembly 22
First terminal 23
Second terminal 24
Shell 3
First shell body 31
Second shell body 32
Third through-hole 321
Fourth through-hole 322
Fifth through-hole 323
Conductive piece 4
Sampling piece 5
First connecting piece 61
First connecting portion 611
Second connecting piece 62
Second connecting portion 621
First filler 71
Second filler 72
First cell 81
Second cell 82
First direction X
Second direction Y
Third direction Z

This application is further described below with reference to the following specific some embodiments and the foregoing drawings.

### DETAILED DESCRIPTION

The following describes the technical solutions in some embodiments of this application with reference to the drawings hereto. Evidently, the described some embodiments are merely a part of but not all of some embodiments of this application.

It is hereby noted that a component considered to be “connected to” another component may be directly connected to the other component or may be connected to the other component through an intermediate component. A component considered to be “disposed on” another component may be directly disposed on the other component or may be disposed on the other component through an intermediate component.

Unless otherwise defined, all technical and scientific terms used herein have the same meanings as usually understood by a person skilled in the technical field of this application. The terms used in the specification of this application herein are merely intended for describing specific some embodiments but are not intended to limit this application. The term “and/or” used herein includes any and all combinations of one or more related items preceding and following the term.

Understandably, when the two components are arranged parallel or perpendicular to each other in the same direction, an angle may exist between the two components. A tolerance of 0% to ±5% is allowed for the angle between the two components, and the measurement errors of the two components may be greater than, equal to, or less than the tolerance of 0 to ±5%.

The following further describes some embodiments of this application with reference to drawings.

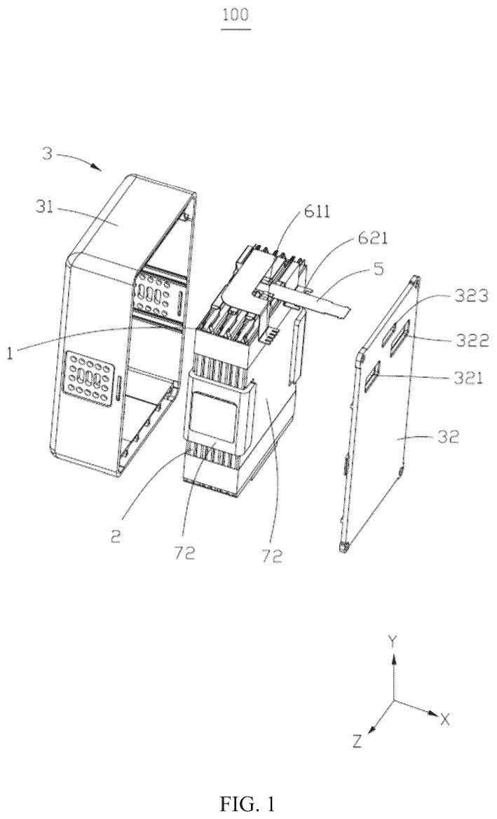

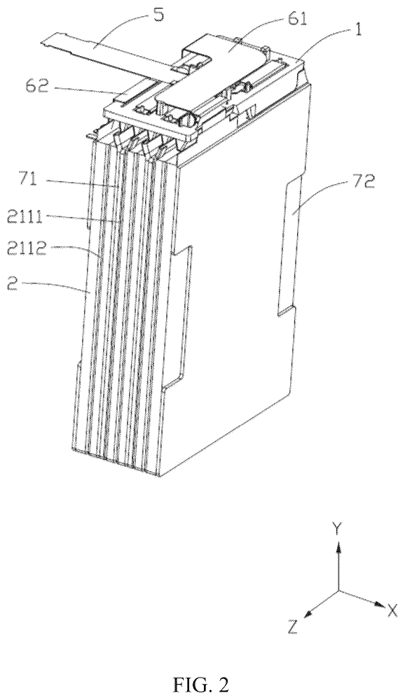

As shown in FIG. 1 and FIG. 2, an embodiment of this application provides a battery module 100, including a shell 3, a bracket 1, and a plurality of cells 2. The shell 3 includes a first shell body 31 and a second shell body 32. The first shell body 31 and the second shell body 32 form an accommodation space. The plurality of cells 2 are stacked in sequence along the first direction X. The plurality of cells 2 are connected to the bracket 1 and then accommodated in the accommodation space.

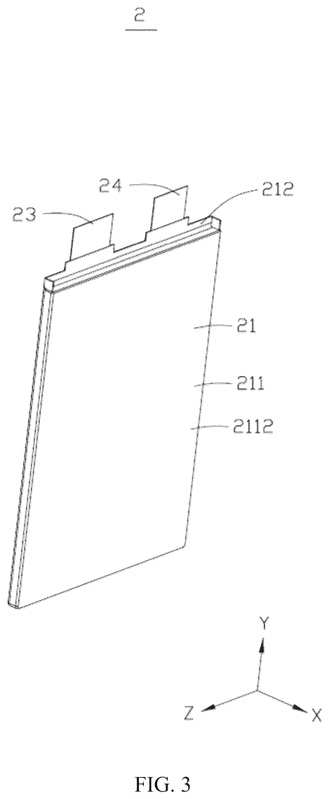

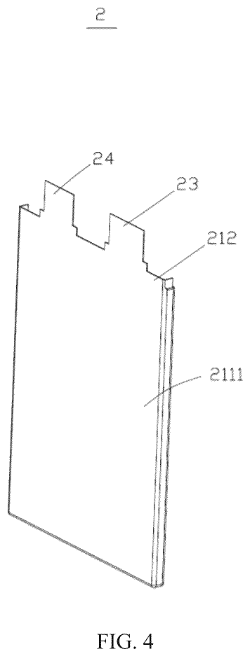

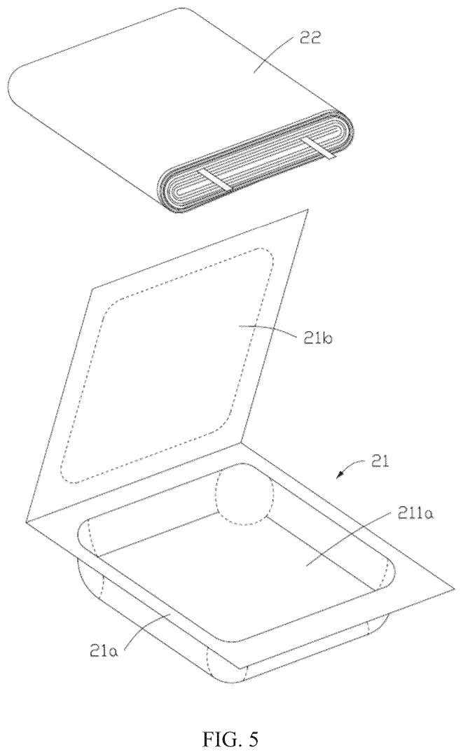

As shown in FIG. 3, FIG. 4, and FIG. 5, the cell 2 includes a cell housing 21, an electrode assembly 22, a first terminal 23, and a second terminal 24. The electrode assembly 22 is accommodated in the cell housing 21. The first terminal 23 and the second terminal 24 are connected to the electrode assembly 22, and protrude out of the cell housing 21. The electrode assembly 22 includes a jelly-roll structure formed by winding a positive electrode plate, a negative electrode plate, and a separator. Further, the cell housing 21 includes an accommodation portion 211 and an edge sealing portion 212 that are connected to each other. The edge sealing portion 212 is located at an edge of the accommodation portion 211, and extends outward from the accommodation portion 211. The electrode assembly 22 is accommodated in the accommodation portion 211. The first terminal 23 and the second terminal 24 protrude out of the edge sealing portion 212. An extension direction of a lateral edge at which the cell 2 is connected to the bracket 1 is a third direction Z. The first terminal 23 and the second terminal 24 of at least one cell 2 are spaced apart in sequence along the third direction Z.

In some embodiments, the cell housing 21 includes a first region 21a and a second region 21a. The first region 21a contains a first space 211a. The electrode assembly 22 is disposed in the first space 211a. The second region 21b is approximately a flat plate-like structure. The first region 21a is connected to the second region 21b. A lateral edge of the first region 21a is connected to the lateral edge of the second region 21b to form a plurality of edge sealing portions 212. The first terminal 23 and the second terminal 24 extend beyond the cell housing 21 from one of the edge sealing portions 212.

The polarity of the first terminal 23 is opposite to the polarity of the second terminal 24. One of the first terminal 23 or the second terminal 24 is a positive terminal, and the other is a negative terminal. In some embodiments, the cell housing 21 includes an aluminum plastic film. In this embodiment, an example is described in which the second terminal 24 is a positive terminal and the first terminal 23 is a negative terminal.

Referring to FIG. 3 and FIG. 4, along the first direction X, the accommodation portion 211 includes a first surface 2111 and a second surface 2112 that are opposite to each other. The first surface 2111 and the second surface 2112 are two opposite outer surfaces of the accommodation portion 211. Optionally, the first surface 2111 is disposed in the second region 21b, and the second surface 2112 is disposed in the first region 21a.

Further, the edge sealing portion 212 is located between a plane on which the first surface 2111 is located and a plane on which the second surface 2112 is located. In some embodiments, a distance between the edge sealing portion 212 and the plane on which the first surface 2111 is located is less than a distance between the edge sealing portion 212 and the plane on which the second surface 2112 is located. That is, the edge sealing portion 212 is closer to the first surface 2111.

In some embodiments, along the first direction X, two first surfaces 2111 or two second surfaces 2112 of any two adjacent accommodation portions 211 are disposed opposite to each other.

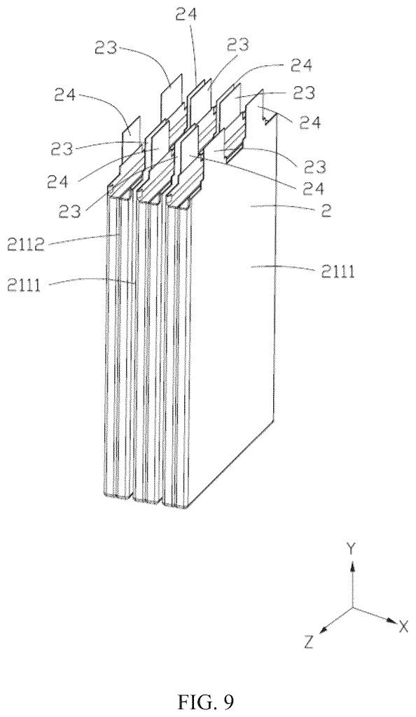

Referring to FIG. 9, in an embodiment, the cells 2 stacked along the first direction X are stacked in such a sequence that the two second surfaces 2112 are disposed opposite to each other and the two first surfaces 2111 are disposed opposite to each other.

In some embodiments, along the first direction X, the first terminal 23 of any one cell 2 is electrically connected to the second terminal 24 of another cell 2 opposite to the first surface 2111 of the cell 2.

In some embodiments, along the first direction X, the second terminal 24 of any one cell 2 is electrically connected to the first terminal 23 of a cell 2 opposite to the second surface 2112 of the cell 2.

In some embodiments, along the first direction X, the first terminal 23 of the cell 2 may be further connected to the first terminal 23 of another cell 2 that is adjacent.

Referring to FIG. 2 and FIG. 9, in some embodiments, along the first direction X, the first terminal 23 of one outermost cell 2 is further connected to the first connecting piece 61, and the second terminal 24 of the other outermost cell 2 is further connected to the second connecting piece 62. The first connecting piece 61 and the second connecting piece 62 are configured to connect external devices. The cell 2 includes a plurality of cells 2 located between the two outermost cells 2. The first terminal 23 of one of the cells 2 is electrically connected to the second terminal 24 of another cell 2 opposite to the first surface 2111 of said cell 2. The second terminal 24 of one of the cells is electrically connected to the first terminal 23 of a cell 2 opposite to the second surface 2112 of said cell 2.

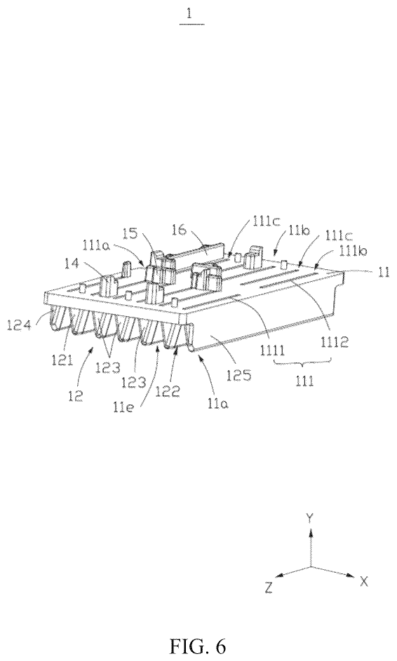

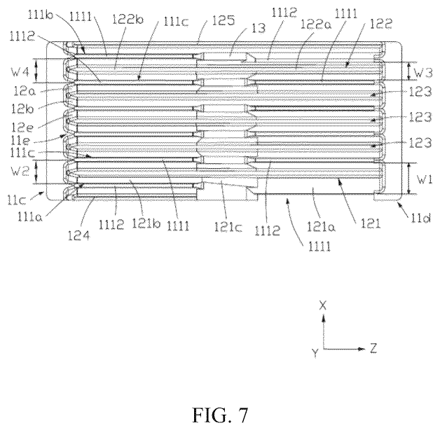

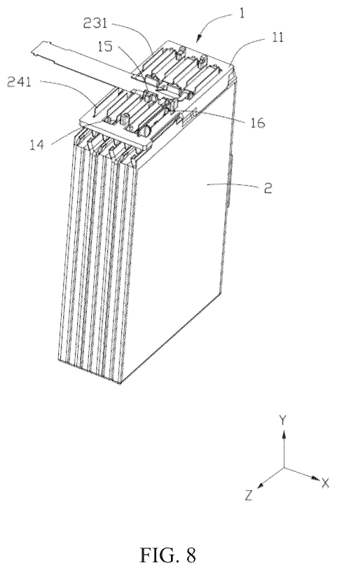

As shown in FIG. 6, FIG. 7, and FIG. 8, the bracket 1 includes a base plate 11 and plurality of groups of protruding portions 12 spaced apart. The base plate 11 is approximately a plate-like structure parallel to a plane formed by the first direction X and the third direction Z. The third direction Z is perpendicular to the first direction X. The base plate 11 includes a first side 11a and a second side 11b that are disposed opposite to each other along a second direction Y. The plurality of groups of protruding portions 12 spaced apart are disposed on the first side 11a of the base plate 11. The second direction Y is perpendicular to a plane formed by the first direction X and the third direction Z.

Referring to FIG. 6 and FIG. 11, a plurality of groups of through-holes 111 arranged along the first direction X are disposed on the base plate 11. The through-holes 111 penetrate the base plate 11 along the second direction Y. At least a part of the through-holes 111 are disposed on the base plate 11 in an elongated shape after extending along the third direction Z. The length of the through-hole 111 along the first direction X is less than the length of the through-hole 111 along the third direction Z. The part of through-holes 111 includes a first terminal through-hole 1111 and a second terminal through-hole 1112 disposed in sequence along the third direction Z. The part of through-holes 111 includes a first terminal through-hole 1111 and a second terminal through-hole 1112 that are disposed in sequence along an opposite direction of the third direction Z. The first terminal 23 and the second terminal 24 of the same cell 2 pass through the first terminal through-hole 1111 and the second terminal through-hole 1112 in the same group respectively.

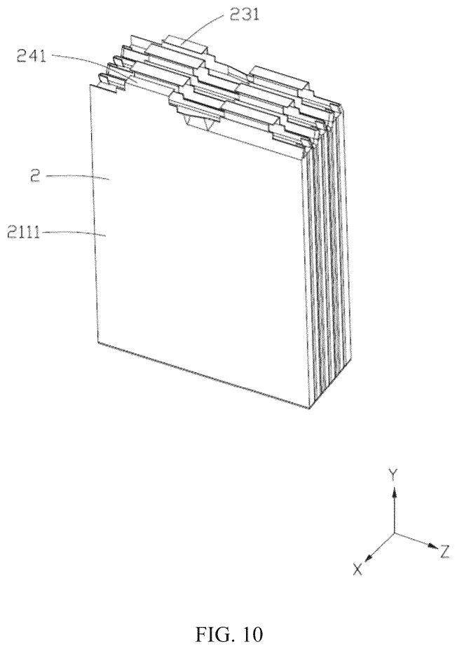

Referring to FIG. 10, in some embodiments, the first terminal 23 includes a first terminal connecting portion 231 that has passed through the first terminal through-hole 1111. The second terminal 24 includes a second terminal connecting portion 241 that has passed through the second terminal through-hole 1112. The first terminal connecting portion 231 and the second terminal connecting portion 241 are located on the second side 11b of the base plate 11.

Referring to FIG. 11 and FIG. 14, in some embodiments, the plurality of groups of through-holes 111 include a first group of through-holes 111a, a second group of through-holes 111b, and third groups of through-holes 111c located between the first group of through-holes 111a and the second group of through-holes 111b, the three group of through-holes being disposed along the first direction X. The number of the third groups of through-holes 111c is at least two.

In an embodiment, the first terminal 23 passes through the first terminal through-hole 1111 in the first group of through-holes 111a. The first terminal connecting portion 231 of the first terminal 23 is connected to the first connecting piece 61. The second terminal 24 passes through the second terminal through-hole 1112 in the second group of through-holes 111b. The second terminal connecting portion 241 of the second terminal 24 is connected to the second connecting piece 62.

Along the first direction X, a distance between the first terminal through-hole 1111 in the first group of through-holes 111a and the second terminal through-hole 1112 in the adjacent third group of through-holes 111c is D1. Among two adjacent third groups of through-holes 111c, the second terminal through-hole 1112 in one group and the first terminal through-hole 1111 in the other group are disposed opposite to each other along the first direction X. A distance between the two terminal through-holes is D3, and D1 is greater than D3. Such arrangement increases the distance between the first terminal 23 inside the first terminal through-hole 1111 in the first group of through-holes 111a and the second terminal 24 inside the second terminal through-hole 1112 in the adjacent third group of through-holes 111c, reduces risks of short circuits between the first terminal 23 and the second terminal 24, increases the connection area, and makes it convenient to dispose the first connecting piece 61, thereby reducing risks of short circuits between the first connecting piece 61 and the second terminal 24 inside the adjacent third group of through-holes 111c.

Referring to FIG. 16 and FIG. 17, in an embodiment, along the first direction X, a distance between the first terminal through-hole 1111 in the first group of through-holes 111a and a first terminal through-hole 1111 in the adjacent third group of through-holes 111c is D1. Along the first direction X, among two adjacent third groups of through-holes 111c, the first terminal through-hole 1111 in one group and the first terminal through-hole 1111 in the other group are disposed opposite to each other along the first direction X, and a distance between the two first terminal through-holes is D3.

In an embodiment, a difference between D1 and D3 is greater than 6 mm, thereby helping to increase the connection area between the first connecting piece 61 and the first terminal 23, and reinforce a weld region between the first connecting piece 61 and the first terminal 23.

In an embodiment, the base plate 11 includes a first lateral edge 11A and a second lateral edge 11B. Along the first direction X, an end that is of the first terminal through-hole 1111 in the first group of through-holes 111a and that is oriented away from the second group of through-holes 111b penetrates the second lateral edge 11B of the base plate 11. This makes it convenient to fold outward the first terminal connecting portion 231 disposed inside the first terminal through-hole 1111 in the first group of through-holes 111a, and weld the first terminal connecting portion to the first connecting piece 61.

The distance between the second terminal through-hole 1112 in the second group of through-holes 111b and the first terminal through-hole 1111 of the adjacent third group of through-holes 111c is D2, and D2 is less than D3, thereby reducing the distance between the second group of through-holes 111b and the adjacent third group of through-holes 111c, and adjusting the distance between the first terminal through-hole 1111 in the first group of through-holes 111a and the second group of through-holes 111b.

In an embodiment, the base plate 11 includes a first lateral edge 11A and a second lateral edge 11B. Along the first direction X, a distance between the second terminal through-hole 1112 in the second group of through-holes 111b and the first lateral edge 11A of the base plate 11 is d21, and a distance between the first terminal through-hole 1111 in the second group of through-holes 111b to the first lateral edge 11A of the base plate 11 is d22, and d21 is greater than d22. This helps to increase the distance between the second terminal through-hole 1112 in the second group of through-holes 111b and the first lateral edge 11A of the base plate 11, and facilitates welding between the second terminal connecting portion 241 and the second connecting piece 62. Optionally, d21 is greater than d22 by 2 mm to 4 mm.

Referring to FIG. 6 and FIG. 7, the plurality of groups of protruding portions 12 and the base plate 11 are integrally formed by injection molding. The plurality of groups of protruding portions 12 are disposed in sequence and spaced out on the first side 11a of the base plate 11 along the first direction X, and the plurality of groups of protruding portions 12 extend along the third direction Z on the surface of the base plate 11. The plurality of groups of interstices are formed between the plurality of groups of protruding portions 12. Viewed along the second direction Y, the through-hole 111 is located between two adjacent protruding portions 12. The through-hole 111 communicates with the interstices. One through-hole 111 exists between any two adjacent protruding portions 12.

When the plurality of cells 2 are stacked and disposed on the bracket 1, each group of through-holes 111 corresponds to one cell 2. Specifically, the first terminal 23 and the second terminal 24 of the same cell 2 penetrate into the first terminal through-hole 1111 and the second terminal through-hole 1112 in each group of through-holes 111 respectively. A part of the first terminal 23, a part of the second terminal 24, and the edge sealing portion 212 of the cell 2 are located between the two adjacent protruding portions 12. In some embodiments, after the first terminal 23 passes through the first terminal through-hole 1111 and after the second terminal 24 passes through the second terminal through-hole 1112, the first terminal connecting portion 231 of the first terminal 23 and the second terminal connecting portion 241 of the second terminal 24 can bend to implement series or parallel connection between adjacent cells 2.

Further, in an opposite direction of the second direction Y, the width of each group of protruding portions 12 in the first direction X decreases gradually. To be specific, a cross-sectional shape of the protruding portion 12 in the third direction Z is approximately V-shaped. The tip of the V shape is oriented facing away from the base plate 11 along the second direction Y. The width of the interstice between two adjacent protruding portions 12 in the first direction X decreases gradually along the second direction Y. Understandably, when the first terminal 23 and the second terminal 24 move into the interstice between the two protruding portions 12, the surface of the protruding portions 12 can guide the movement of the first terminal 23 and the second terminal 24, and guide the first terminal 23 and the second terminal 24 to move closer to the base plate 11 until penetrating into the through-hole 111.

In some embodiments, a minimum distance between two adjacent protruding portions 12 is equal to the width of the through-hole 111 along the first direction X.

In an embodiment, viewed along the second direction Y, the plurality of groups of protruding portions 12 include a first group of protruding portions 121, a second group of protruding portions 122, and a third group of protruding portions 123. The first group of protruding portions 121 is located between the first group of through-holes 111a and the adjacent third group of through-holes 111c. The second group of protruding portions 122 is located between the second group of through-holes 111b and the third group of through-holes 111c adjacent to the second group of through-holes 111b. The third group of protruding portions 123 is located between two adjacent third groups of through-holes 111c, and located between the first group of protruding portions 121 and the second group of protruding portions 122.

Viewed along the second direction Y, the first group of protruding portions 121 includes a first part 121a and a second part 121b, the first part 121a located between the first terminal through-hole 1111 in the first group of through-holes 111a and the second terminal through-hole 1112 in the third group of through-holes 111c adjacent to the first group of through-holes, the second part 121b located between the second terminal through-hole 1112 in the first group of through-holes 111a and the first terminal through-hole 1111 in the third group of through-holes 111c adjacent to the first group of through-holes. Projected along the second direction Y, a width of a projection of the first part 121a on the base plate 11 along the first direction X is W1, a width of a projection of the second part 121b on the base plate 11 along the first direction X is W2, and W1 is greater than W2. This helps the first terminal 23 of the first part 121a to keep away from the second terminal 24 inside the adjacent third group of through-holes 111c along the first direction X, increases the distance between the first terminal 23 and the second terminal 24, and reduces risks of short circuits between the first terminal 23 and the second terminal 24.

When the first terminal 23 and the second terminal 24 of the same cell 2 abut on the first part 121a and the second part 121b, respectively, the cell 2 moves closer to the base plate 11 along the second direction Y. The first part 121a and the second part 121b can serve a function of guidance, and guide the first terminal 23 and the second terminal 24 to move closer to the base plate 11 until penetrating into the first terminal through-hole 1111 and the second terminal through-hole 1112, respectively.

In some embodiments, along the first direction X, a distance between the first part 121a and the second group of protruding portions 122 is equal to a distance between the second part 121b and the second group of protruding portions 122.

Viewed along the second direction Y, the second group of protruding portions 122 includes a third part 122a and a fourth part 122b, the third part 122a located between the second terminal through-hole 1112 in the second group of through-holes 111b and the first terminal through-hole 1111 in the third group of through-holes 111c adjacent to the second group of through-holes, and the fourth part 122b located between the first terminal through-hole 1111 in the second group of through-holes 111b and the second terminal through-hole 1112 in the third group of through-holes 111c adjacent to the second group of through-holes. Projected along the second direction Y, a width of a projection of the third part 122a on the base plate 11 along the first direction X is W3, a width of a projection of the fourth part 122b on the base plate 11 along the first direction X is W4, and W3 is less than W4. During the assembling, such an arrangement helps to provide a guidance and achieve the following effects: the second terminal 24 inside the second terminal through-hole 1112 in the second group of through-holes 111b is disposed close to the adjacent third group of through-holes 111c; and the distance between the first terminal through-hole 1111 in the second group of through-holes 111b and the adjacent third group of through-holes 111c is equal to D3.

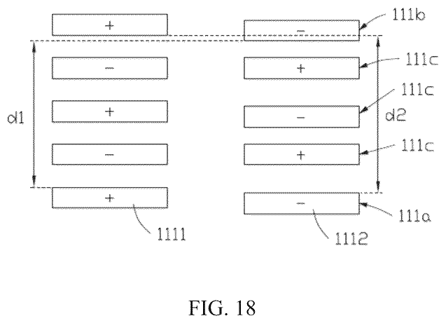

In an embodiment, the difference between D1 and D3 is equal to the difference between D3 and D2. The distance between the first terminal through-hole 1111 in the second group of through-holes 111b and the adjacent third group of through-holes 111c is equal to D3, and the distance between the second terminal through-hole 1112 in the first group of through-holes 111a and the adjacent third group of through-holes 111c is equal to D3. Referring to FIG. 18, along the first direction X, a distance between the first terminal through-hole 1111 in the first group of through-holes 111a and the second group of through-holes 111b is d1, a distance between the second terminal through-hole 1112 in the first group of through-holes 111a and the second group of through-holes 111b is d2, and d1 is equal to d2, thereby helping to make the following two lengths consistent by cutting: a length by which the first terminal 23 extends beyond the cell housing 21, and a length by which the second terminal 24 extends beyond the cell housing 21, and facilitating production.

In an embodiment, the first group of protruding portions 121 further includes a fifth part 121c. The fifth part 121c is connected to the first part 121a and the second part 121b. Along the second direction Y, a width of a projection of the fifth part 121c on the base plate 11 along the first direction X increases gradually from an end connected to the second part 121b to an end connected to the first part 121a. A lateral surface that is of the fifth part 121c and that is oriented facing away from the second group of protruding portions 122 is smoothly connected to a lateral surface that is of the first part 121a and that is oriented facing away from the second group of protruding portions 122, and is configured to guide a part of the structure of the edge sealing part 212 from the second part 121b to the first part 121a.

Understandably, the protruding portion 12 further includes a fourth group of protruding portions 124 and a fifth group of protruding portions 125. The fourth group of protruding portions 124 is disposed and spaced out along the first direction X on a side that is of the first group of protruding portions 121 and that is oriented away from the third group of protruding portions 123. The second terminal through-hole 1112 in the first group of through-holes 111a is located between the first group of protruding portions 121 and the fourth group of protruding portions 124. The fourth group of protruding portions 124 fits with the adjacent first group of protruding portions 121 to form interstices, so as to guide the second terminal 24. The fifth group of protruding portions 125 is disposed and spaced out along the first direction X on a side that is of the second group of protruding portions 122 and that is oriented away from the third group of protruding portions 123. The first terminal through-hole 1111 and the second terminal through-hole 1112 in the second group of through-holes 111b are located between the second group of protruding portions 122 and the fifth group of protruding portions 125. The fifth group of protruding portions 125 fits with the adjacent first group of protruding portions 121 to form interstices, so as to guide the first terminal 23 and the second terminal 24. Understandably, the lateral edges that are of the fourth group of protruding portions 124 and the fifth group of protruding portions 125 and that are close to the base plate 11 are in the same plane as the lateral edge of the base plate 11 in the second direction Y

The base plate 11 further includes a third side 11c and a fourth side 11d that are disposed opposite to each other along the third direction Z. The base plate 11 further includes an opening 11e made on the third side 11c. Along the third direction Z, the opening 11e communicates with a plurality of groups of interstices between the plurality of groups of protruding portions 12. The first terminal 23 and the second terminal 24 enter the space between the two adjacent groups of protruding portions 12 along the third direction Z from an opening 11e on the third side 11c of the base plate 11.

In an embodiment, a first beveled face 12a and a second beveled face 12b are disposed at ends that are of the plurality of groups of protruding portions 12 and that are located on the third side 11c. The first beveled face 12a and the second beveled face 12b are disposed toward the interstices between adjacent protruding portions 12. A distance between the first beveled face 12a and the second beveled face 12b of the same group of protruding portions 12 along the first direction X increases gradually from the third side 11c to the fourth side 11d. To be specific, along the first direction X, the distance between the first beveled face 12a and the second beveled face 12b of the protruding portion 12 adjacent to the first beveled face decreases gradually from the third side 11c to the fourth side 11d, so as to make the opening 11e flare out. In this way, the first terminal 23 and the second terminal 24 can be conveniently guided into the interstices between the two adjacent groups of protruding portions 12, and the success rate of docking the cell 2 to the bracket 1 is increased.

Understandably, on the fourth side 11d, an opening 11e and a corresponding beveled face may also be disposed and configured to guide the first terminal 23 and the second terminal 24 into the interstices between the two groups of protruding portions 12.

Understandably, in a process of plugging the first terminal 23 and the second terminal 24 into the bracket 1, the first terminal 23 and the second terminal 24 enter the two adjacent protruding portions 12 first from the opening 11e on the third side 11c along the third direction Z. The first terminal 23 and the second terminal 24 continue to move along the second direction Y. During the movement, the width of the interstice between the two adjacent protruding portions 12 in the first direction X decreases gradually along the second direction Y. At the same time, the first terminal 23 and the second terminal 24 are guided along the first direction X and the second direction Y until moving to the preset position. Subsequently, the first terminal 23 is plugged into the first terminal through-hole 1111 and the second terminal 24 is plugged into the second terminal through-hole 1112 along the second direction Y. During the movement along the second direction Y, the outer surface of the protruding portion 12 guides the first terminal 23 and the second terminal 24 into the through-hole 111, thereby helping to improve the success rate of plugging.

The bracket 1 further includes a partitioning portion 13. The partitioning portion 13 is disposed between the first terminal through-hole 1111 and the second terminal through-hole 1112 in the same group of through-holes 111. After the first terminal 23 and the second terminal 24 of the cell 2 pass through the first terminal through-hole 1111 and the second terminal through-hole 1112 respectively, the partitioning portion 13 is located between the first terminal connecting portion 231 and the second terminal connecting portion 241. Understandably, the partitioning portion 13 can reduce the probability of other foreign substances dropping into a space between the first terminal through-hole 1111 and the second terminal through-hole 1112 in the same group, thereby reducing the risk of a short circuit between the first terminal 23 and the second terminal 24 caused by the foreign substances. Optionally, the partitioning portion 13 can enhance structural strength of the bracket 1.

As shown in FIG. 9 and FIG. 10, after passing through the through-hole 111, the first terminal 23 and the second terminal 24 are bent toward each other and connected together. By bending in this way, the plurality of cells 2 can be connected in series or parallel.

Understandably, along the first direction X, among two outermost cells 2, the first terminal 23 of one cell 2 and the second terminal 24 of the other cell 2 are not connected in series to the adjacent cell 2. Such first terminal 23 and second terminal 24 can be electrically connected to an external device by serving as an output end of the series circuit.

In this application, an outer side means a side oriented back from the stacking center. The two outermost cells 2 mean the two cells 2 located at two ends of the first direction X among the stacked cells 2.

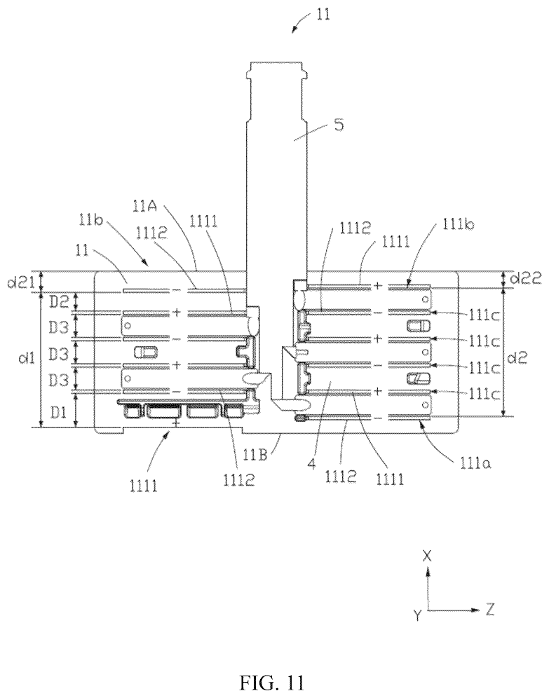

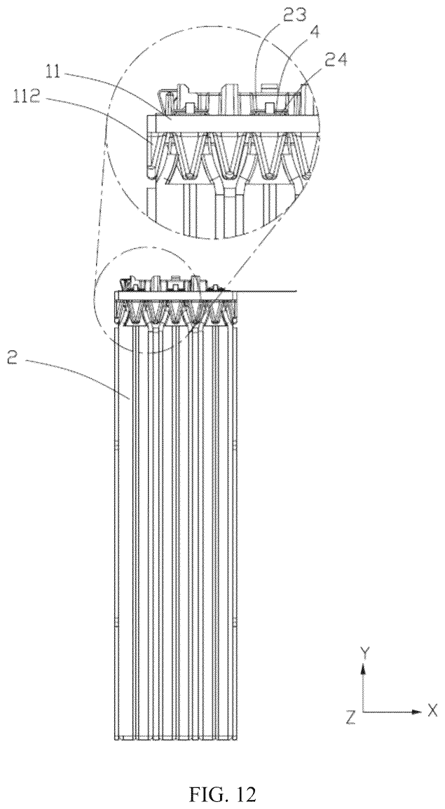

As shown in FIG. 11 and FIG. 12, the battery module 100 further includes a conductive piece 4 and a sampling piece 5. The conductive piece 4 and the sampling piece 5 are disposed on the second side 11b of the base plate 11.

Viewed from an opposite direction of the second direction Y, the conductive piece 4 is disposed between the first terminal through-hole 1111 and the second terminal through-hole 1112 that are adjacently disposed along the first direction X. The first terminal connecting portion 231 and the second terminal connecting portion 241 are connected to the conductive piece 4. Along the first direction X, the lengths of the conductive pieces 4 are identical. In this way, the areas of welding the first terminal connecting portion 231 and the second terminal connecting portion 241 to the conductive piece 4 are the same between adjacent cells 2, thereby helping to keep consistency of the cells 2 and improve the service life of the battery module 100.

When the first terminal 23 and the second terminal 24 adjacent to each other along the first direction X are bent toward each other, the bent second terminal 24 is located at a lower position. The second terminal 24 abuts on and is electrically connected to the conductive piece 4. The first terminal 23 abuts on and is electrically connected to the second terminal 24.

Understandably, when the bent first terminal 23 is located below the second terminal 24, the first terminal 23 abuts on and is electrically connected to the conductive piece 4. The second terminal 24 abuts on and is electrically connected to the first terminal 23.

One end of the sampling piece 5 is connected to the base plate 11 and electrically connected to all the conductive pieces 4, and another end protrudes beyond the base plate 11. The sampling piece 5 electrically connects the plurality of conductive pieces 4 to all the cells 2, so as to be able to collect and transmit data information on safety circuit boards of all the cells 2.

In this application, the conductive piece 4 and the sampling piece 5 are pre-arranged on the bracket 1, and the sampling piece 5 is welded onto the conductive piece 4. When the first terminal 23 and the second terminal 24 of the cell 2 penetrate into the through-hole 111 and are connected to the bracket 1, the sampling piece 5 is connected to all the cells 2, thereby improving the work efficiency.

In some embodiments, the sampling piece 5 includes a sampling line.

In some embodiments, the conductive piece 4 includes a metal material.

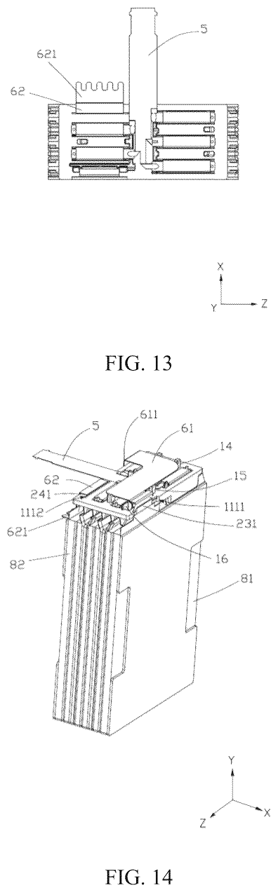

As shown in FIG. 13 and FIG. 14, the two outermost cells 2 are the first cell 81 and the second cell 82. The second terminal 24 on the first cell 81 is not connected to the first terminal 23 of the adjacent cell 2. The first terminal 23 on the second cell 82 is not connected to the second terminal 24 of the adjacent cell 2.

One end of the first connecting piece 61 is connected to the first terminal connecting portion 231 of the first terminal 23 of the first cell 81, and another end protrudes out of the bracket 1 from outside of the first cell 81. One end of the second connecting piece 62 is electrically connected to the second terminal connecting portion 241 of the second terminal 24 of the second cell 82, and another end protrudes out of the bracket 1 from outside of the second cell 82.

A first connecting portion 611 is disposed at an end that is of the first connecting piece 61 and that is oriented away from the first cell 81. A second connecting portion 621 is disposed at an end that is of the second connecting piece 62 and that is oriented away from the second cell 82. The first connecting portion 611 and the second connecting portion 621 protrude from the same side of the stacked cells 2, and protrude from the same side as the sampling piece 5. Understandably, the first connecting portion 611, the second connecting portion 621, and the sampling piece 5 are led out from the same side, thereby facilitating connection to an external device and improving space efficiency. In other embodiments, the first connecting portion 611 and the second connecting portion 621 are disposed on different sides of the bracket 1.

In some embodiments, a first insulation rod 14 and a second insulation rod are further disposed on the bracket 1. The first insulation rod 14 and the second insulation rod 15 are disposed on the second side 11b of the base plate 11.

One end of the first insulation rod 14 is fixedly connected to the base plate 11, and another end abuts on the first connecting piece 61. The first connecting piece 61 is electrically connected to the bent first terminal 23, thereby reducing the probability of short circuits. In some embodiments, the number of the first insulation rods 14 is plural, and the plurality of first insulation rods 14 are evenly distributed on the surface of the base plate 11. Understandably, the plurality of first insulation rods 14 can well support the first connecting piece 61, and reduce the probability of a short circuit caused by contact between the first connecting piece 61 and the bent first terminal 23 or second terminal 24.

One end of the second insulation rod 15 is fixedly connected to the base plate 11, and another end abuts on a lateral face and a bottom face of the first connecting piece 61. A support face and an abutment face are provided on the second insulation rod 15. The support face abuts on a side that is of the first connecting piece 61 and that is close to the base plate 11. The abutment face abuts on the lateral face of the first connecting piece 61. In some embodiments, the number of the second insulation rods is plural, and the plurality of second insulation rods 15 are disposed on two sides of the first connecting piece 61 along the second direction Y. Understandably, the plurality of second insulation rods 15 not only supports the first connecting piece 61 and reduces the risks of short circuits caused by contact between the first connecting piece 61 and the bent first terminal 23 or second terminal 24, but also brings a good position-limiting effect to limit the displacement of the first connecting piece 61 along the second direction Y

An insulation block 16 is further disposed on the bracket 1. The insulation block 16 is disposed on the second side 11b of the base plate 11, and is located between the first terminal through-hole 1111 in the first group of through-holes 111a and the adjacent third group of through-holes 111c. The length of the insulation block 16 along the third direction Z is greater than the length of the through-hole 111 on the either side of the insulation block 16 along the third direction Z. The insulation block 16 is disposed protrusively on the base plate 11 along the second direction Y, and is configured to carry the first connecting piece 61 and obstruct the first connecting piece 61 and the first terminal 23 welded on the first connecting piece 61 from contacting the adjacent second terminal 24, thereby reducing risks of short circuits between the first connecting piece 61 and the second terminal 24 in the third group of through-holes 111c.

In some embodiments, the first connecting piece 61 and the second connecting piece 62 are made of a metal material.

In some embodiments, the first insulation rod 14 and the second insulation rod 15 are made of an insulation material.

Still referring to FIG. 1 and FIG. 2, the battery module 100 further includes a first filler 71 and a second filler 72.

The first filler 71 fill in the space between two opposite first surfaces 2111, and the two ends of the first filler 71 abut on the two first surfaces 2111 respectively. Understandably, the first filler 71 can cause two opposite first surfaces 2111 to abut against each other, so as to reduce the risks of short circuits between the two cells 2 corresponding to the two first surfaces 2111.

The second filler 72 is disposed between the shell 3 and the stacked cells 2. Understandably, the second filler 72 can reduce risks of shaking of the cells 2 inside the packaged battery module 100.

In some embodiments, the first filler 71 and the second filler 72 are foam.

In some embodiments, a third through-hole 321, a fourth through-hole 322, and a fifth through-hole 323 are disposed on the second shell body 32. The third through-hole 321 corresponds to the first connecting portion 611. The fourth through-hole 322 corresponds to the second connecting portion 621. The third through-hole 321 and the fourth through-hole 322 are penetrable to the first connecting portion 611 and the second connecting portion 621 respectively. The fifth through-hole 323 corresponds to the sampling piece 5. The fifth through-hole 323 is penetrable to the sampling piece 5.

The first connecting portion 611, the second connecting portion 621, and the sampling piece 5 protrude out of the second shell body 32 through the third through-hole 321, the fourth through-hole 322, and the fifth through-hole 323, respectively, so as to be able to connect to external devices and transmit electrical energy of the stacked cells 2 and data information on safety circuit boards of all the cells 2.

Referring to FIG. 11, in this embodiment, the number of cells 2 is an even number. The first terminal through-hole 1111 in the first group of through-holes 111a and the second terminal through-hole 1112 in the second group of through-holes 111b are disposed opposite to each other along the first direction X. Along the first direction X, the projection of the first terminal through-hole 1111 at least partly overlaps the projection of the second terminal through-hole 1112. Referring to FIG. 18, in other embodiments, the number of cells 2 is an odd number. The first terminal through-hole 1111 in the first group of through-holes 111a and the first terminal through-hole 1111 in the second group of through-holes 111b are disposed opposite to each other along the first direction X.

Referring to FIG. 11, in this embodiment, the plurality of cells 2 are connected in series. Between the plurality of adjacent groups of through-holes 111c, the first terminal through-hole 1111 and the second terminal through-hole 1112 are disposed opposite to each other along the first direction X. Along the first direction X, the projection of the first terminal through-hole 1111 at least partly overlaps the projection of the second terminal through-hole 1112.

In other embodiments, between the plurality of adjacent groups of through-holes 111c, the first terminal through-hole 1111 may be separated from the second terminal through-hole 1112 along the first direction X. Along the first direction X, the projection of the first terminal through-hole 1111 may be separated from the projection of the second terminal through-hole 1112.

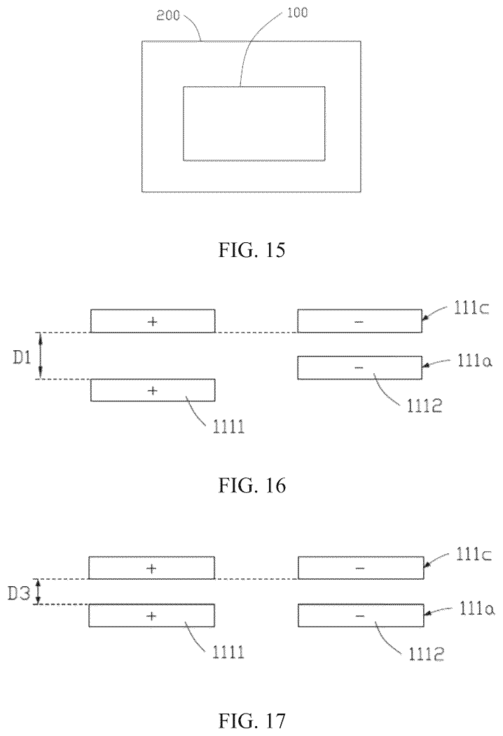

Referring to FIG. 15, this application further provides an electrical device 200 containing the battery module 100 according to any one of the foregoing some embodiments. The battery module 100 is ready for use after being connected to the electrical device through a line. In an embodiment, the electrical device 200 according to this application may be, but without being limited to: a pen-inputting computer, a mobile computer, a portable fax machine, a portable photocopier, a portable printer, a stereo headset, a video recorder, a liquid crystal display television set, a handheld cleaner, a transceiver, an electronic notepad, a calculator, a backup power supply, a motor, an electric vehicle, an electric motorcycle, a power-assisted bicycle, an electric tool, a large household battery, or the like.

To sum up, in the battery module 100 and the electrical device 200 according to this application, the first terminal 23 and the second terminal 24 are guided along the third direction Z from the lateral edge to the interstice between the two adjacent protruding portions 12 first. The width of the interstice between the two adjacent protruding portions 12 in the first direction X is made to decrease gradually along the second direction Y. Further, along the first direction X and the second direction Y, the first terminal 23 and the second terminal 24 are guided to be plugged into the through-hole 111, thereby improving the assembling efficiency. The first beveled face 12a and the second beveled face 12b are disposed at the ends of the plurality of groups of protruding portions 12. The distance between the first beveled face 12a and the second beveled face 12b along the first direction X increases gradually from the third side 11c to the fourth side 11d. This makes it convenient to guide the first terminal 23 and the second terminal 24 into the interstice between two adjacent groups of protruding portions 12, and improves the success rate of docking the battery cell 2 to the bracket 1. The protruding portion 12 is located between the first terminal 23 and the second terminal 24 that are adjacent to each other, and can serve a function of insulation. By increasing the distance between the first terminal through-hole 1111 in the first group of through-holes 111a and the second terminal through-hole 1112 in the third group of through-holes 111c adjacent to the first group of through-holes, this application increases the distance between the first terminal connecting portion 231 connected and the first connecting piece 61 and the adjacent second terminal connecting portion 241, thereby reducing risks of short circuits caused by deficient spacing between the first terminal connecting portion 231 and the second terminal connecting portion 241.

In addition, a person skilled in the art may make other variations to this application without departing from the essence of this application. The variations made based on the content hereof still fall within the protection scope of this application.

What is claimed is:

1. A battery module, comprising:
a plurality of cells, stacked along a first direction, wherein each cell comprises a first terminal and a second terminal, and a polarity of the first terminal is opposite to a polarity of the second terminal;
a bracket comprising a plurality of groups of through-holes, wherein each group of through-holes comprises a first terminal through-hole and a second terminal through-hole, and the first terminal and the second terminal of a same cell pass through the first terminal through-hole and the second terminal through-hole in a same group of through-holes respectively;
wherein, the plurality of groups of through-holes comprise a first group of through-holes, a second group of through-holes, and a plurality of third groups of through-holes located between the first group of through-holes and the second group of through-holes;
along the first direction, a distance D1 between the first terminal through-hole in the first group of through-holes and the second terminal through-hole in a third group of through-holes adjacent to the first group of through-holes is greater than a distance D3 between two adjacent third groups of through-holes.

2. The battery module according to claim 1, wherein, in the two adjacent third groups of through-holes, a distance between the first terminal through-hole in one of the two adjacent third groups of through-holes and the second terminal through-hole in the other of the two adjacent third groups of through-holes is D3;
the first terminal through-hole in the one of the two adjacent third groups of through-holes and the second terminal through-hole in the other of the two adjacent third groups of through-holes are disposed opposite to each other along the first direction.

3. The battery module according to claim 1, wherein a difference between D1 and D3 is greater than 6 mm.

4. The battery module according to claim 1, wherein a distance between the second terminal through-hole in the second group of through-holes and the first terminal through-hole in a third group of through-holes adjacent to the second group of through-holes is D2, and D2 is less than D3.

5. The battery module according to claim 1, wherein, along the first direction, a distance d1 between the first terminal through-hole in the first group of through-holes and the second terminal through-hole in the second group of through-holes is equal to a distance d2 between the second terminal through-hole in the first group of through-holes and the first terminal through-hole in the second group of through-holes.

6. The battery module according to claim 1, wherein the bracket further comprises a base plate and a plurality of groups of protruding portions, the plurality of groups of protruding portions are spaced apart from each other;
the base plate comprises a first side and a second side, the first side and the second side are disposed opposite to each other along a second direction, and the plurality of groups of protruding portions are located on the first side of the base plate;
viewed along the second direction, the plurality of groups of protruding portions comprise a first group of protruding portions located between the first group of through-holes and the third group of through-holes adjacent to the first group of through-holes, a second group of protruding portions located between the second group of through-holes and the third group of through-holes adjacent to the second group of through-holes, and a third group of protruding portions located between the first group of protruding portions and the second group of protruding portions;
the first group of protruding portions comprises a first part located between the first terminal through-hole in the first group of through-holes and the second terminal through-hole in the third group of through-holes adjacent to the first group of through-hole, and a second part located between the second terminal through-hole in the first group of through-holes and the first terminal through-hole in the third group of through-holes adjacent to the first group of through-holes; and
projected along the second direction, a width of a projection of the first part on the base plate along the first direction is W1, a width of a projection of the second part on the base plate along the first direction is W2, and W1 is greater than W2.

7. The battery module according to claim 6, wherein along the first direction, a distance between the first part and the second group of protruding portions is equal to a distance between the second part and the second group of protruding portions.

8. The battery module according to claim 6, wherein each group of protruding portions gradually diminishes in size along an opposite direction of the second direction.

9. The battery module according to claim 6, wherein when viewed along the second direction, the second group of protruding portions comprises a third part located between a second terminal through-hole in the second group of through-holes and a first terminal through-hole in the third group of through-holes adjacent to the second group of through-holes, and a fourth part located between a first terminal through-hole in the second group of through-holes and a second terminal through-hole in the third group of through-holes adjacent to the second group of through-holes;
projected along the second direction, a width of a projection of the third part on the base plate along the first direction is W3, a width of a projection of the fourth part on the base plate along the first direction is W4, and W3 is less than W4.

10. The battery module according to claim 6, wherein along the first direction, the base plate comprises a second lateral edge and a first lateral edge, a distance between the second terminal through-hole in the second group of through-holes and the first lateral edge is d21, a distance between the first terminal through-hole in the second group of through-holes and the first lateral edge is d22, and d21 is greater than d22.

11. The battery module according to claim 6, wherein along the first direction, the base plate comprises a second lateral edge and a first lateral edge; and an end of the first terminal through-hole in the first group of through-holes is oriented away from the second group of through-holes and penetrates the second lateral edge.

12. The battery module according to claim 6, wherein the bracket comprises a third side and a fourth side, the third side and the fourth side are disposed opposite to each other along a third direction;
the bracket comprises an opening provided on the third side, a plurality of groups of interstices are formed between the plurality of groups of protruding portions; and, along the third direction, the opening communicates with the plurality of groups of interstices.

13. The battery module according to claim 12, wherein a first beveled face and a second beveled face are disposed at an end of the plurality of groups of protruding portions, the end being an end located on the third side; and a distance between the first beveled face and the second beveled face of a same group of protruding portions along the first direction increases gradually.

14. The battery module according to claim 1, wherein the cell further comprises:
a cell housing, wherein the cell housing comprises an accommodation portion and an edge sealing portion extending outward from the accommodation portion, and the accommodation portion comprises a first surface and a second surface, the first surface and the second surface are disposed opposite to each other along the first direction;
the first terminal and the second terminal protrude beyond the cell housing from the edge sealing portion; and
an electrode assembly, wherein the electrode assembly is accommodated in the accommodation portion, and the first terminal and the second terminal are electrically connected to the electrode assembly.

15. The battery module according to claim 14, wherein the edge sealing portion is disposed between a plane where the first surface is located and a plane where the second surface is located, and the edge sealing portion is closer to the first surface than the second surface.

16. The battery module according to claim 6, wherein the first terminal and the second terminal are connected to each other by bending toward each other, the first terminal comprises a first terminal connecting portion passing through the first terminal through-hole, and the second terminal comprises a second terminal connecting portion passing through the second terminal through-hole;
the battery module further comprises a plurality of conductive pieces, and the plurality of conductive pieces are disposed on a side of the base plate, the side of the base plate being a side oriented facing away from the protruding portion;
the first terminal connecting portion and the second terminal connecting portion are connected to the conductive piece; and
the bracket further comprises a partitioning portion located on the first side of the base plate, and the partitioning portion is disposed between the first terminal through-hole and the second terminal through-hole in a same group of through-holes.

17. The battery module according to claim 16, wherein the battery module further comprises a sampling piece, and the sampling piece is disposed on a side of the base plate, the side of the base plate being a side oriented facing away from the protruding portion, and is connected to the conductive piece.

18. The battery module according to claim 12, wherein the battery module further comprises:
a first connecting piece, wherein one end of the first connecting piece is connected to the first terminal, the first terminal passes through the first terminal through-hole in the first group of through-holes, and another end of the first connecting piece comprises a first connecting portion; and
a second connecting piece, wherein one end of the second connecting piece is connected to the second terminal, the second terminal passes through the second terminal through-hole in the second group of through-holes, another end of the second connecting piece comprises a second connecting portion, and the first connecting portion and the second connecting portion are located on a same side of the base plate.

19. The battery module according to claim 18, wherein the bracket further comprises an insulation block, the insulation block is disposed on the second side of the base plate and is located between the first terminal through-hole in the first group of through-holes and an adjacent third group of through-holes;
along the third direction, a length of the insulation block is greater than a length of the first terminal through-hole in the first group of through-holes.

20. An electrical device, wherein the electrical device comprises the battery module according to claim 1.
